(19) United States
(12) Patent Application Publication
(10) Pub. No.: US 2012/0084150 A1
(43) Pub. Date: Apr. 5, 2012

(54) EBOOK ADVERTISING AND RELATED TECHNIQUES

(75) Inventors: Dale Nussel, Mahomet, IL (US); Jonathan Kilroy, Champaign, IL (US); Allie K. Watfa, Urbana, IL (US); Anupam Seth, Urbana, IL (US)

(73) Assignee: Yahoo! Inc., Sunnyvale, CA (US)

(21) Appl. No.: 12/895,755

(22) Filed: Sep. 30, 2010

(51) Int. Cl. G06Q 30/00

(52) U.S. Cl. 705/14.55

(57) ABSTRACT

Techniques are provided in which a first set of information is obtained regarding ebook content evidenced as being accessed by an ebook reader, such as a page or paragraph being read, for example. Based at least in part on the ebook content, a second set of information is obtained, including multiple ebook advertising targeting parameters. Based at least in part on the targeting parameters, at least one advertisement is targeted to the ebook reader, in which the at least one advertisement is to be presented to the reader at least in part via the ebook.

### BACKGROUND

Ebook purchasing has grown dramatically in scale in recent years and continues to grow (where ebooks can include electronic books, magazines, newspapers, other forms of electronic reading material, etc.). Yet advertising directed or targeted to ebook readers, and associated monetization techniques, has been less than optimal and has not fully taken advantage of opportunities presented by ebook reading.

There is a need for better techniques for advertising that may be directed to or targeted to ebook readers.

### SUMMARY

Some embodiments of the invention provide techniques that include allowing an ebook reader to select an advertising setting which specifies permissible forms of advertising to be presented to the ebook reader via one or o ebooks. Based at least in part on the selected setting, the ebook reader may be provided with a reduction relating to the cost of the one or more ebooks. The reduction may be greater if the selected option indicates more valuable permissible advertising. Permissible advertising may be presented to the ebook reader via at least one of the one or more ebooks. In some embodiments, the advertising may be targeted based in part on ebook content, which can include content evidenced as being accessed by the ebook reader at a time of advertisement serving.

In some embodiments, techniques are provided in which a first set of information is obtained regarding ebook content evidenced as being accessed by an ebook reader, such as a page or paragraph being read, for example. Based at least in part on the ebook content, a second set of information is obtained, including multiple ebook advertising targeting parameters. Based at least in part on the targeting parameters, at least one advertisement is targeted to the ebook reader, in which the at least one advertisement is to be presented to the reader at least in part via the ebook.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a flow diagram illustrating a method according to one embodiment of the invention; and

FIG. 5 is a block diagram illustrating one embodiment of the invention;

FIG. 6 is a flow diagram illustrating a method according to one embodiment of the invention;

FIG. 7 is a flow diagram illustrating a method according to one embodiment of the invention; and

FIG. 8 is a block diagram illustrating one embodiment invention.

While the invention is described with reference to the above drawings, the drawings are intended to be illustrative, and the invention contemplates other embodiments within the spirit of the invention.

### DETAILED DESCRIPTION

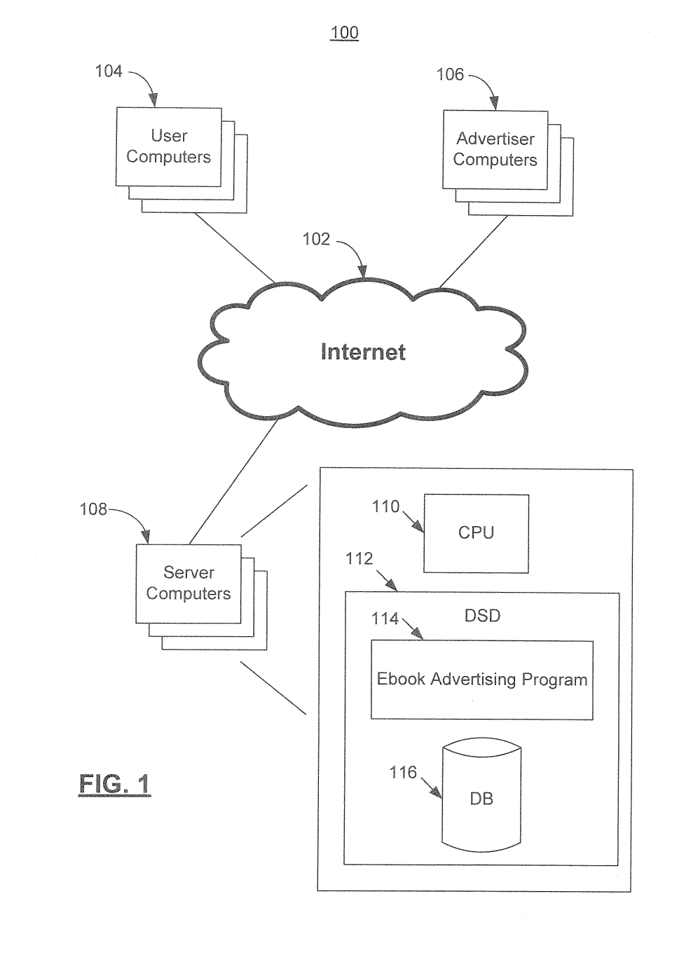

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, algorithms, programs and tools. Depicted computers may also include a hard drive, monitor, keyboard, pointing or, selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and an Ebook Advertising Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

Various monetization techniques or models may be used in connection with advertising, such as sponsored search advertising, including advertising associated with user search queries, and non-sponsored search advertising, including graphical or display advertising. In an auction-based online advertising marketplace, advertisers may bid in connection with placement of advertisements, although many other factors may also be included in determining advertisement selection or ranking. Bids may be associated with amounts the advertisers pay for certain specified occurrences, such as for placed or clicked-on advertisements, for example.

Advertiser payment for online advertising may be divided between parties including one or more publishers or publisher networks, and one or more marketplace facilitators or providers, potentially among other parties. Some models include guaranteed delivery advertising, in which advertisers may pay based on an agreement guaranteeing or providing some measure of assurance that the advertiser will receive a certain agreed upon amount of suitable advertising, and non-guaranteed delivery advertising, which may be individual serving opportunity-based or spot market-based. In various models, advertisers may pay based on any of various metrics associated with advertisement delivery or performance, or associated with measurement or approximation of a particular advertiser goal. For example, models can include, among other things, payment based on cost per impression or number of impressions, cost per click or number of clicks, cost per action for some specified action, cost per conversion or purchase, or cost based on some combination of metrics, which can include online or offline metrics. In some embodiments of the invention, payment may be based on assessed favorable branding or brand engagement value, for example.

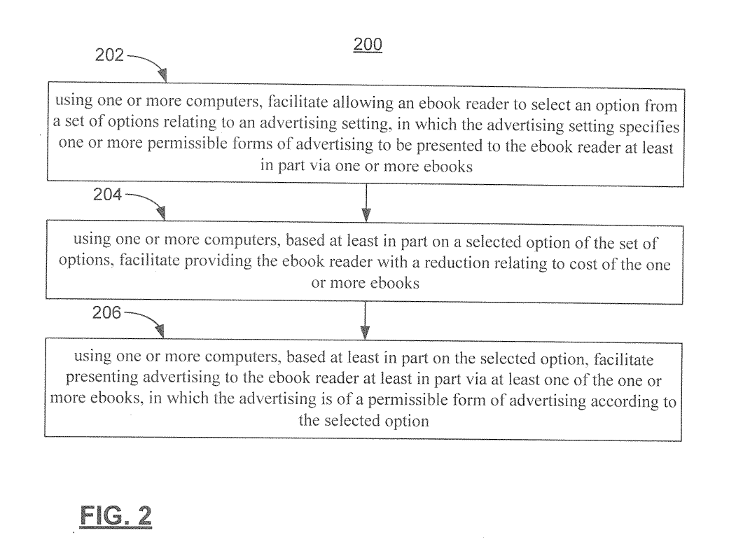

FIG. 2 is a flow diagram illustrating a method 2 according to one embodiment of the invention. At step 202, using one or more computers, the method 200 includes facilitating allowing an ebook reader to select an option from a set of options relating to an advertising setting, in which the advertising setting specifies one or more permissible forms of advertising to be presented to the ebook reader at least in part via one or more ebooks.

At step 204, using one or more computers, based at leas part on a selected option of the set of options, the method 200 includes facilitating providing the ebook reader with a reduction relating to cost of the one or more ebooks.

At step 206, using one or more computers, based at least in part on the selected option, the method 200 includes facilitating presenting advertising to the ebook reader at least in part via at least one of the one or more ebooks, in which the advertising is of a permissible form of advertising according to the selected option.

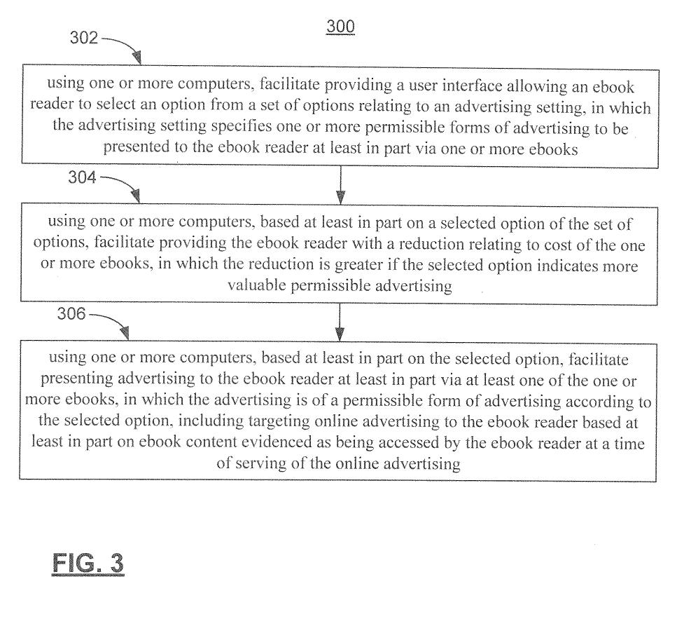

FIG. 3 is a flow diagram illustrating a method 300 according to one embodiment of the invention.

At step 302, using one or more computers, the method 300 includes facilitating providing a user interface allowing an ebook reader to select an option from a set of options relating to an advertising setting, in which the advertising setting specifics one or more permissible forms of advertising to be presented to the ebook reader at least in part via one or more ebooks.

At step 304, using one or more computers, based a east in part on a selected option of the set of options, the method 300 includes facilitating providing the ebook reader with a reduction relating to cost of the one or more ebooks, in which the reduction is greater if the selected option indicates more valuable permissible advertising.

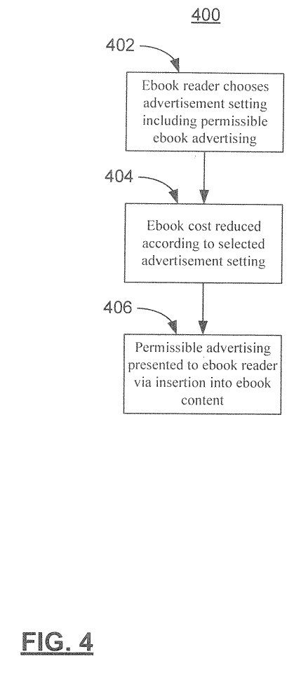

FIG. 4 is a flow diagram illustrating a method 400 according to one embodiment of the invention. At step 402, an ebook reader chooses an advertisement setting including permissible ebook advertising.

At step 404, the ebook cost is reduced according to selected advertisement setting.

At step 406, permissible advertising presented to ebook reader via insertion into ebook content.

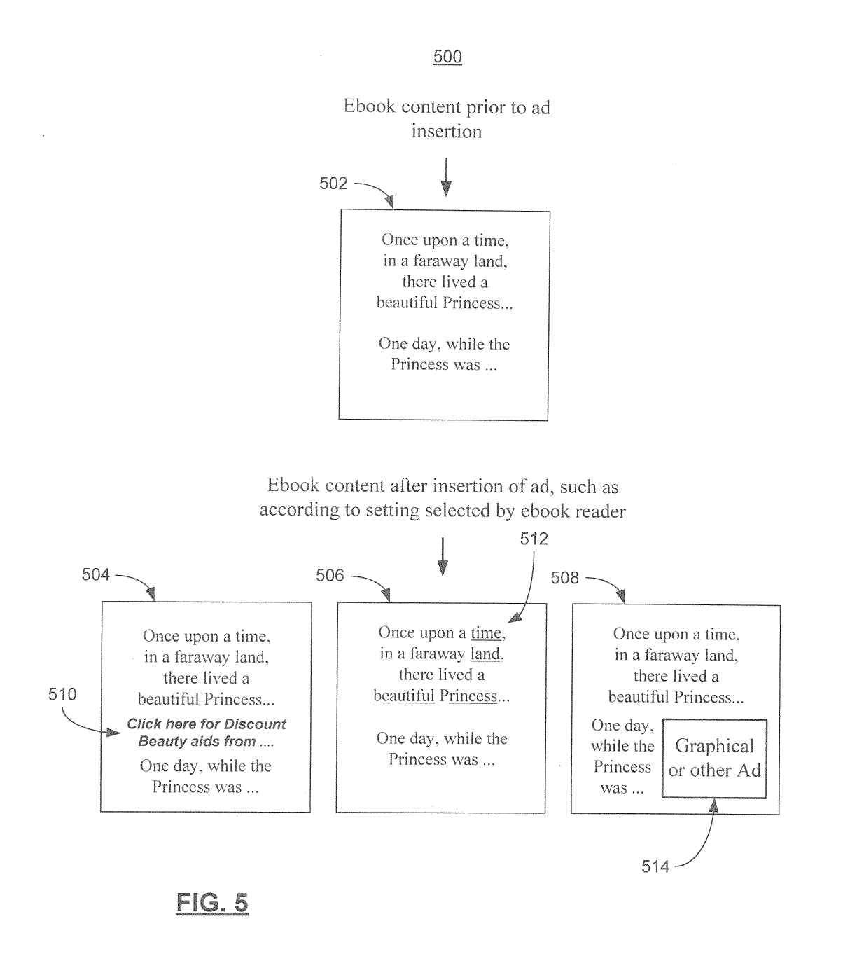

FIG. 5 is a block diagram 500 illustrating one embodiment of the invention. Block 502 is simplified depiction of ebook content, such as a portion of an ebook page, prior to insertion of any advertisements.

Blocks 504, 506 and 508 arc simplified depictions of ebook content after insertion of an advertisement. In some embodiments, the advertisement is of a permissible type as indicated by a setting selected by the ebook reader.

In depiction 504, block 510 is a simplified depiction of an advertisement reading, “Click here for discount beauty aids from . . . ”, inserted within the text of a page in the ebook.

In depiction 506, hyperlinked terms 512 are included in the text of the ebook page, where selecting a hyperlinked term may cause the ebook user to be presented with an associated advertisement, or may take the ebook user, if online, to a Web page associated with the hyperlinked term, for example.

In depiction 508, a graphical or rich media advertisement 514 is inserted in an area of an ebook page, and ebook text is shifted as appropriate to make space for it. The advertisement could of any of various types, such as a graphical advertisement, a video or audio advertisement, etc.

As further described below, the depicted advertisements 510, 512, 514 could be targeted, among other ways, according to ebook content, which could include content evidenced as being accessed by an online ebook reader a time of serving of the advertisement, including the accessed term, sentence, paragraph, page, chapter, book, book series, author, etc., as well as specific topical and referenced topics or other items or information of the content, such as referenced people, places, things, emotional or mood associations, the genre or area of the book, etc.

IN some embodiments, advertising can be based on a mood and setting of content being accessed. For example, if the setting includes young characters, a Coke advertisement could be provided, inviting the reader to enjoy a glass of Coke with his or his book, and providing a graphic of a cool glass of Coke, etc.

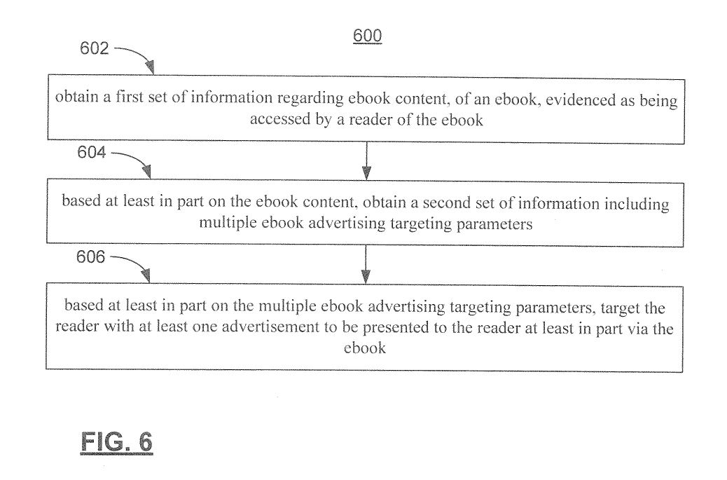

FIG. 6 is a flow diagram illustrating a method 600 according to one embodiment of the invention. At step 602, a first set of information is obtained, regarding ebook content, of an ebook, evidenced as being accessed by a reader of the ebook.

At step 604, based at least in part on the ebook content, a second set of information is obtained, including multiple ebook advertising targeting parameters.

At step 606, based at least in part on the multiple ebook advertising targeting parameters, the reader is targeted with at least one advertisement to be presented to the reader at least in part via the ebook.

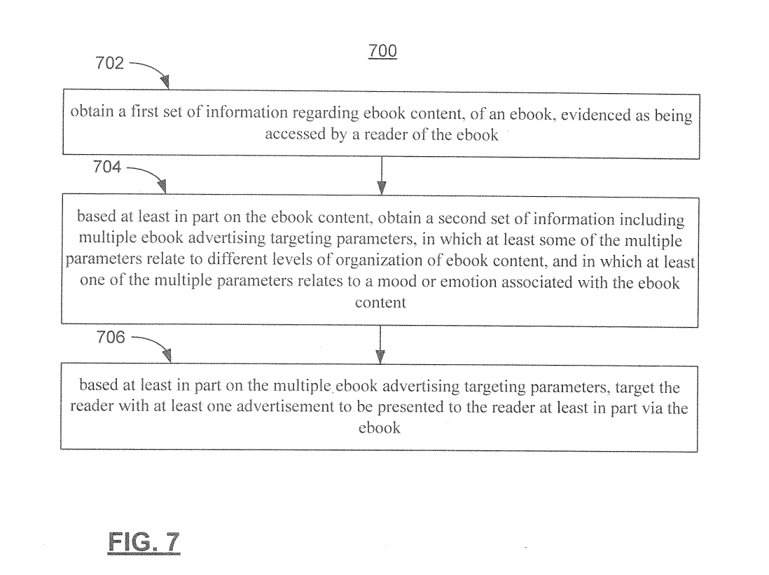

FIG. 7 is a flow diagram illustrating a method 700 according one embodiment of the invention. Step 702 is similar to step 602 as depicted in FIG. 6.

At step 704, based at least in part on the ebook content, a second set of information is obtained, including multiple ebook advertising targeting parameters, in which at least some of the multiple parameters relate to different levels of organization of ebook content, and in which at least one of the multiple parameters relates to a mood or emotion associated with the ebook content.

Step 706 is similar to step 606 as depicted in FIG. 6.

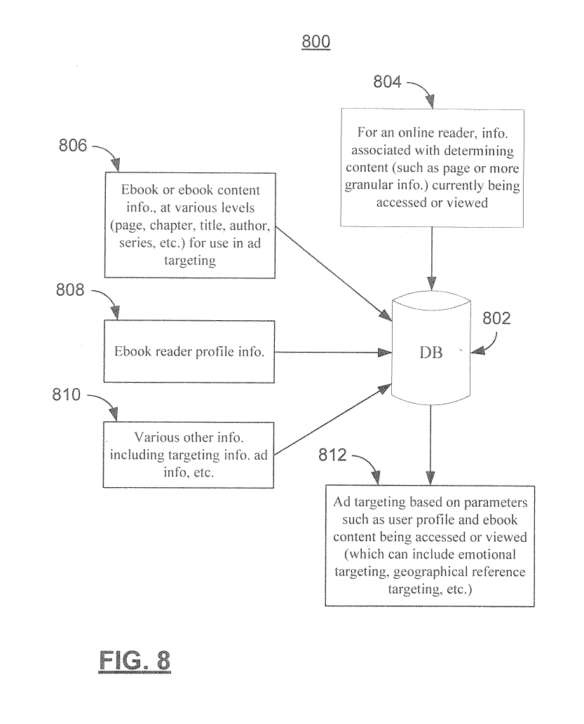

FIG. 8 is a block diagram illustrating one embodiment of the invention. Various types of information are stored in a database 802, including, potentially among other things, ebook and ebook content info., at various levels (word or words, term or terms, paragraph, page, chapter, book title, book series, author, etc,) for use in ad targeting 806, ebook reader profile info. 808, and various other info. including targeting info. ad info, etc. 810, as well as, for an online reader, info. associated with determining content (such as page or more granular info.) currently being accessed or viewed 804.

Block 812 represents ad targeting based on parameters such as an ebook reader profile and ebook content being accessed or viewed (which can include emotional targeting, geographical reference targeting, etc.).

In some embodiments of the invention, ebook users select a type, nature, degree, or level of advertising that ill be allowed. In return, they may receive benefit, such as a discount on the cost of the associated ebook or ebooks, for example. The benefit, such as the amount of the cost reduction, may be associated with the level of advertising permitted. For example, greater levels of advertising, which may be more valuable to an advertiser and potentially more distracting to an ebook reader, may warrant higher discounts, etc.

Furthermore, in some embodiments, an ebook reader may be able to make a selection with regard to the type or even quality, desirability or class of permitted advertising. As a simple example, high class advertising ay include generally high-impact or highly targeted, relatively desirable advertising. Middle class advertising could include everyday types of advertisements, such as advertisements for everyday products like pizza, etc. Lower class advertising could include advertisements that may be pervasive or generally undesirable, such as teeth whitener advertisements, “lower your mortgage” type advertisements, etc. In some embodiments, the ebook reader's selection in this regard may affect or factor into the provided discount or value, such as by providing a higher or increased discount for selection of lower class advertisements, for example.

In some embodiments, an ebook purchaser and reader may be able, within potentially certain limits, to determine the price that the reader will pay for an ebook, by selecting an advertisement setting that provides a suitable or sufficient discount.

In various embodiments, various parties may be involved in and share in benefit from use of techniques according to the invention, including, for example, the ebook reader, seller, publisher, and advertiser.

In some embodiments, advertisements may be inserted prior to ebook reading, such as being inserted in a static or unchanging fashion prior to downloading of the ebook, for example, such as if the reader is reading offline. In some embodiments, advertisements may be inserted in a dynamic fashion, such as online and based on real-time targeting, which can include targeting based on ebook reading, including a chapter or page being accessed by the reader, etc. In some embodiments, hybrid advertising techniques may be utilized, employing both static and dynamic advertising.

In some embodiments, a formula may be utilized in determining a price for an ebook. For example, in some en bodiments. When a customer buys an e-book, the person can be give him a choice of:
1) Buying the book without any ads at regular price (WeightFactor=0);
2) Buying the book with in-line, hyper-linked ads from keywords in the text content of the books (WeightFactor=a1);
3) Buying the book with in-laid text ads (WeightFactor=a2);
4) Buying the book with in-laid pages/display ads (WeightFactor=a3).
   The customer could configure to sec an advertisement at a certain frequency, or every N number of pages, for example, where N is configurable, and here higher frequencies, or lower N's, lead to deeper discounts, or may even be great enough to allow the ebook to be obtained for free.

To continue example, a formula such as the following could be used for computing the price of the e-book:

Price=Publisher price−(Freq. of advertisements×No. of pages purchased*WeightFactor)*(% giveBack*Revenue per advertisement), Publisher price may be the competitive market price for which the publisher would like to offer the book nor ally, for example.

Freq. of advertisements may be the user-configured frequency of seeing an advertisement, for example. Higher no, of pages purchased may lead to higher advertising volume and a greater discount. The weighting factor may be associated with the type of allowed advertising and its effectiveness or performance, or forecasted effectiveness or performance. The % giveBack may be the advertisement revenue percent shared with the end-consumer, for example. Revenue per advertisement may be the average revenue earned by advertisement generation for the specific class or category of allowed advertising or advertisements.

In some embodiments, advertisers may also choose to give incentives like refunding the cost of the e-book in the event of a directly-consequential click or purchase, online or offline, from or determined to be associated with or caused by a displayed advertisement. This could be an easy low-cost incentive for high-priced items such as laptops, etc.

Various forms of advertisement targeting could be employed. For example, in some embodiments, techniques could be use in with an advertisement is selected based at least in part using targeting attributes of various priorities. As just one simple example, a flow process could be utilized, including a flow through priorities 1, 2 and 3 listed below. Priority 1 comprise of type of ebook and interest, priority 2 will be user profile setting, priority 3 will be security and filtration.

Priority 1 could include:
A—Type of ebook and method of pricing
B—Interest indicated as part of user's profile
C—Interest indicated at time of ebook purchase

Priority 2 could include:
C—IP location of user at time of purchase
D—Interest indicated as part of users profile
E—User Gender

Priority 3 could include:
F—appropriateness of advertisement
G—Age of user
H—local user filtration

To continue the example, the system could go through the sequential and continuous flow of A, B, C, D, E, F, G and H, with A having the most impact and then the priority declining as we go down the queue. Of course, many other examples and targeting techniques are possible.

As mentioned above, embodiments of the invention contemplate static advertising as well as dynamic or online advertising, or hybrid techniques making use of both.

In some embodiments, advertising, such as online advertising, is targeted based at least in part on ebook content evidenced as being accessed by an ebook reader. Being targeted based on ebook content can include, for example, being targeted based on parameters relating to various levels of organization of the book associated accessed content, including, for example, a word, words, term, sentence, paragraph, chapter, or even book or book or book title (even though obviously an entire chapter may not be being accessed, but rather content within the chapter, for example). Targeting can also be based on higher level or less directly associated parameters, such as book author, book series, etc.

Any of various techniques or combinations of techniques can be used in embodiments of the invention in determining (whether for certain or with any of various levels of confidence or certainty), estimating or guessing what content is being accessed or is likely to be being accessed. In some embodiments forecasting and predicting based on various information may be utilized, including factors relating to the ebook as well as potentially the reader or the reading, such as the reader's rate of reading, scrolling information etc. Utilized information could include zooming-in or other viewing tools used by the reader. Furthermore, in some embodiments, machine learning or other sophisticated techniques could be employed in making determinations or predictions. In some embodiments, it may be straightforward to determine a page of the ebook being accessed by an online reader at a given time, for instance. In some embodiments, it may be possible to determine or guess, with varying degrees of confidence, at more granular levels, such as down to a sentence or even term or word being accessed or read.

Some embodiments of the invention include targeting that takes advantage of accessed content targeting at several different levels of organization with regard to the ebook. For example, targeting could be based on a topic or mood associated with the title of the book as well as a topic or mood associated with content at a more granular level, such as the particular chapter, or even paragraph or sentence, for example. In some embodiments, a combination of such parameters is utilized, which ay be more effective than targeting based on each individually. As just one illustrative example, if a book title relates to wineries, and a particular chapter relates to a particular area of California, then advertising could relate to a winery in that area of California, etc.

In some embodiments, advertising may be presented that relates to content being accessed and may tempt the reader or draw the reader's attention with associated useful information or suggestions, along with or otherwise in association with advertising a product or service, for example. For example, at the bottom of a page, an advertisement could be presented that offers or provides a summary of that page or chapter, or an upcoming page or chapter, or that indicates most popular quotes from the book and indicates “brought to you by Company A”, etc. An advertisement could also, for example, suggest or recommend to an ebook reader a previous or the next book in the series, etc. Furthermore, advertisements could use various techniques to encourage further reader engagement, such as by providing the reader with tools, such as a tool to share a paragraph of quote from the ebook, or to visit a site or blog associated with accessed content and also associated with or including advertising associated with the advertiser, etc.

Some embodiments take advantage of or include use of social networking information, such as such explicit or implicit social networking information associated with the ebook reader. For example, sonic targeting parameters could relate to others a social network of the reader, or associated interests, trending, etc. Furthermore, implicit social networks could be identified for this purpose, such as by determining users that also purchased or read the ebook that the reader is reading, or users that read similar books or hooks by the same author, or publisher, for example. In some embodiments, advertisers can provide criteria relating to such.

In some embodiments, social networking information could be included in the advertisement itself, such as by indicating to the ebook reader that other readers of that book liked a product, or liked certain other books, for example. Furthermore, in some embodiments, advertisements could recommend related or targeted media or entertainment of various types, such as movies, music, etc.

In some embodiment, tagging by users relating to ebooks and ebook content can be used in targeting. For example, while reading, ebook users may tag ebook content or particular advertising, such as by indicating a simple like or dislike, or by providing more granular opinions. Such tagging could then be used as a parameter in targeting an ebook user with advertising. For example, tagging by users in an explicit or implicit social network of a particular ebook reader could be utilized, emphasized, etc.

In some embodiments, targeting parameters can include not only targeting based on a geographic location of the user, or setting of the ebook, for example, but could also be more broadly or additionally based on geographic or location references in the ebook.

In some embodiments, emotional or mood-based targeting is utilized, such as by taking into account an emotional state or situation associated with content being accessed, etc.

In some embodiments, targeting may take into account specific item or situational references in content being accessed, which could include sensory or sense-associated references. For example if content being accessed includes a character enjoying a relaxing cup of hot tea, advertisements could be provided relating to that item, or relaxing drinks or other comfort food products, etc.

In some embodiments, targeting parameters may be bas a least in part on user profiles, which can include any of various aspects, including emotional or other profile aspects. Profiles can build using various information including information regarding user choices, tagging, preferences, choices, etc.

In some embodiments, advertising can take advantage of aspects of accessed content that may include human senses and sensations that the author is attempting to convey. An example of this might relate to, from the book, “Polar Express”, the passage, “ . . . as the kids got seated, the waiter started to serve refreshing hot cocoa as thick and rich as melted chocolate bars . . . . ” This may be an excellent opportunity to show an advertisement for hot cocoa or a Hersey's chocolate bar, as the reader has already been acclimated or positively predisposed by the story he or she is immersed in.

In some embodiments, keywords (which can be words or terms of ebook content, or associated with the ebook or portions thereof, etc.) and tags are utilized, and categories of such, and detected patterns and can trigger advertising associated with the keywords and tags, etc. For example, if keywords or tags relate to love or affection, advertisements can be provided that relate to flowers, food or entertainment, for example.

Furthermore, in some embodiments, a progression over multiple chapters or subjects show that there is a certain mood and tone that falls under a particular category, such as vacations, for example, then the system may detect this pattern and match advertising to the context, such as advertising relating to a vacation offer. As such, some embodiments include using moods and emotions associated with the book in addition to a detected context to trigger advertising that is relevant to both. Furthermore, historical information regarding activities of the book reader, such as previous ebooks read by the reader, can be used to further guide and enrich targeting. For example, if the historical information indicates an inclination toward or preference for a particular mood, situation, or topic, or even specific likes such as movies, for instance, then this can be used in targeting or filtering of advertising.

As mentioned above, tagging can be used in some embodiments of the invention. Three types of uses of tagging follow, which may be used in embodiments of the invention.

In some embodiments, if, through a single chapter or subject, keywords and tags suggest showing an advertisement relating to a particular keyword, then the system may detect this and one or more advertisements may be triggered that tail into this keyword. For example, if advertisements showing love and affection are suggested in this way, then advertisements relating to flowers, food or entertainment may be shown.

Another example of a use of tagging involves collective instances of keywords and tags. For example, if, through multiple chapters or subjects that follow each other, it is suggested that there is a certain mood and tone that falls under one category, such as vacations, then the system will detect this pattern and match it to a context. Using the ebook's mood and emotions plus the detected context may trigger advertisements that provide relevant subject matter, such as advertisements that show a destination for a vacation.

Still another example of a use of tagging could involve collective instances of keywords and tags in addition to historical information that may reflect reader interests or likes. For example, if through multiple chapters or subjects plus the history of another book that the user is reading or has read, it is suggested that a certain interest, inclination, mood, or situation is prevalent, then the system may attempt to filter and detect the subject that is associated with this trigger, and then associate it with the history of what the reader likes. This could include showing advertisements relating to movies or other forms of entertainment that may reflect the likes of the reader.

While the invention is described with reference o the above drawings, the drawings are intended to be illustrative, and the invention contemplates other embodiments within the spirit of the invention.

1. A method comprising:
obtaining a first set of information regarding ebook content, of an ebook, evidenced as being accessed by a reader of the ebook;
based at least in part on the ebook content, obtaining a second set of information comprising multiple ebook advertising targeting parameters; and
based at least in part on the multiple ebook advertising targeting parameters, targeting the reader at least one advertisement to be presented to the reader at least in part via the ebook.

2. The method of claim 1, comprising facilitating serving of the at least one advertisement.

3. The method of claim 1, wherein obtaining the multiple ebook advertising targeting parameters comprises obtaining at least one parameter based at least in part on a portion of the ebook evidenced as being read.

4. The method of claim 1, wherein obtaining the multiple ebook advertising targeting parameters comprises obtaining at least one parameter based at least in part on a page of the ebook evidenced as being read.

5. The method of claim 1, wherein obtaining the multiple ebook advertising targeting parameters comprises obtaining at least one parameter based at least in part on a portion of a page of the ebook evidenced as being read.

6. The method of claim 1, further comprising inserting advertising within ebook content prior to accessing of the content by an offline ebook reader, wherein the advertising is targeted based at least in part on the offline ebook reader and based at least in part on content of the ebook.

7. The method of claim 1, comprising targeting the at least one advertisement based at least in part on e-book related content tagging by users other than the reader.

8. The method of claim 1, comprising obtaining the multiple ebook advertising targeting parameters, wherein at least some of the multiple parameters relate to different levels of organization of ebook content.

9. The method of claim 1, comprising targeting the reader with at least one advertisement, wherein the at least one advertisement comprises an advertisement relating to at least one topic of the book content evidenced as being accessed.

10. The method of claim 1, comprising targeting the reader with at least one advertisement, wherein the at least one advertisement comprises an advertisement relating to an item referenced in the ebook content evidenced as being accessed.

11. The method of claim 1, comprising targeting the reader with at least one advertisement wherein the at least one advertisement comprises an advertisement relating to at least one emotion or mood associated with the ebook content evidenced as being accessed.

12. The method of claim 1, comprising obtaining the multiple ebook advertising targeting parameters, wherein at least one or the multiple parameters relate to geographic locations referenced in the ebook content evidenced as being accessed.

13. The method of claim 1, comprising targeting the reader with the at least one advertisement based at least in part on a profile of the reader.

14. A system comprising:
one or more server computers coupled to a network: and
one or more databases coupled to the one or more server computers;
wherein the one or more server computers are for:
obtaining, and storing in at least one of the one or more databases, a first set of information regarding ebook content, of an ebook, evidenced as being accessed by a reader of the ebook;
based least part on the ebook content, obtaining, and storing in at least one of the one or more databases, a second set of information comprising multiple ebook advertising targeting parameters; and
based at least in part on the multiple ebook advertising targeting parameters, targeting the reader with at least one advertisement to be presented to the reader at least in part via the ebook.

15. The system of claim 14, wherein at least one of the one or more server computers are coupled to the Internet.

16. The system of claim 14, the reader is reading the ebook online.

17. The system of claim 14, comprising facilitating serving of the at least one advertisement.

18. The system of claim 14, wherein obtaining the multiple ebook advertising targeting parameters comprises obtaining at least one parameter based at least in part on a portion of the ebook evidenced as being read.

19. The system of claim 14, wherein obtaining the multiple ebook advertising targeting parameters comprises obtaining at least one parameter based at least in part on a mood or emotion associated with a portion of the ebook evidenced as being read.

20. A computer readable medium or media containing instructions for executing a method comprising:
obtaining a first set of information regarding ebook content, of an ebook, evidenced as being accessed by a reader of the ebook:
based at least in part on the ebook content, obtaining a second set of information comprising multiple ebook advertising targeting parameters;
wherein at least some of the multiple parameters relate to different levels of organization of ebook content, and wherein at least one of the multiple parameters relates to a mood or emotion associated with the ebook content; and
based at least in part on the multiple ebook advertising targeting parameters, targeting the reader with at least one advertisement to be presented to the reader at least in part via the ebook.
